(19) United States
(12) Patent Application Publication
(10) Pub. No.: US 2024/0187127 A1
(43) Pub. Date: Jun. 6, 2024

(54) MODEL-BASED DETERMINATION OF FEEDBACK INFORMATION CONCERNING THE CHANNEL STATE

(71) Applicant: InterDigital Patent Holdings, Inc., Wilmington, DE (US)

(72) Inventors: Yugeswar Deenoo Narayanan Thangaraj, Chalfont, PA (US); Swayambhoo Jain, Milpitas, CA (US); Ghyslain Pelletier, Montreal (CA)

(73) Assignee: InterDigital Patent Holdings, Inc., Wilmington, DE (US)

(21) Appl. No.: 18/285,172

(22) PCT Filed: Mar. 28, 2022
(86) PCT No.: PCT/US2022/022142

§ 371 Date: Sep. 29, 2023

Related U.S. Application Data
(60) Provisional application No. 63/167,838, filed on Mar. 30, 2021.

(51) Int. Cl. H04L 1/00

(52) U.S. Cl. CPC H04L 1/0026

(57) ABSTRACT

A wireless transmit/receive unit (WTRU) may adapt an AI model, e.g., based on changes in computational resources, changes in a power status, etc. For example, a WTRU may determine first channel state information (CSI) feedback information using a first data processing model. The WTRU may determine that a triggering condition associated with use of the first data processing model has been met. The WTRU may determine, based on the determination that the triggering condition has been met, a data processing model to use to determine second CSI feedback information, where the data processing model is different than the first data processing model. The WTRU may transmit an indication of the determined data processing model. The WTRU may determine the second CSI feedback information using the determined data processing model. The WTRU may transmit an indication of the determined second CSI feedback information.

### CROSS-REFERENCE TO RELATED APPLICATIONS

This application claims the benefit of Provisional U.S. Patent Application No. 63/167,838, filed Mar. 30, 2021, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for modifying, adapting and/or changing the processing associated with an artificial intelligence (AI) component in a node (e.g., a wireless transmit/receive unit (WTRU), which may be used as an example of a node).

A WTRU may adapt or change an AI model, e.g., based on changes in computational resources, changes in a power status, etc. For example, a WTRU may determine feedback information (e.g., first channel state information (CSI) feedback information which may be used as an example) using a first data processing model. The WTRU may transmit an indication of the determined first CSI feedback information (e.g., to another node, which may be a base station). The WTRU may determine that a triggering condition associated with use of the first data processing model has been met. The WTRU may determine, based on the determination that the triggering condition has been met, a data processing model to use to determine second CSI feedback information, where the data processing model is different than the first data processing model.

If the triggering condition that has been met is that a change in a processing capability associated with the WTRU exceeds a first threshold, and the change in the processing capability associated with the WTRU is less than a second threshold, the WTRU determines that the data processing model to use to determine the second CSI feedback information is a second data processing model. If the triggering condition that has been met is that the change in the processing capability associated with the WTRU exceeds the second threshold, the WTRU determines that the data processing model to use to determine the second CSI feedback information is a third data processing model. The WTRU may generate a number of hybrid automatic repeat request (HARQ) negative acknowledgements (NACKs) over a preconfigured amount of time. If the triggering condition that has been met is that the number of HARQ NACKs generated over the preconfigured amount of time is greater than a value, the WTRU determines that the data processing model to use to determine the second CSI feedback information is a fourth data processing model. If the triggering condition that has been met is that the WTRU changes from using a first bandwidth part (BWP) to using a second BWP, the WTRU determines that the data processing model to use to determine the second CSI feedback information is a fifth data processing model.

The WTRU may transmit an indication of the determined data processing model (e.g., to another node, which may be the base station). The indication of the determined data processing model may comprise one or more of a reason for the usage of the determined data processing model, a type of adaptation to the first data processing model, or an extent of the adaptation to the first data processing model. The WTRU may determine the second CSI feedback information using the determined data processing model. The WTRU may transmit an indication of the determined second CSI feedback information (e.g., to another node, which may be the base station).

The WTRU may determine the second data processing model by adapting the first data processing model (e.g., for the case where the triggering condition that has been met is that a change in a processing capability associated with the WTRU exceeds a first threshold, and the change in the processing capability associated with the WTRU is less than a second threshold). The WTRU may determine the third data processing model by switching the first data processing model to the third data processing model (e.g., for the case where the triggering condition that has been met is that the change in the processing capability associated with the WTRU exceeds the second threshold).

A data processing model may be one of an artificial intelligence (AI) model, a machine learning (ML) model, or a deep learning (DL) model. The change in the processing capability associated with the WTRU may comprise a change in a processing power allocated for using the first data processing model to generate CSI feedback information.

The first data processing model may comprise a first data processing parameter and the second data processing model may comprise a second data processing parameter. The first data processing parameter may be one of: a first model structure, a first model type, a first layer configuration, a first input dimension, a first output dimension, or a first quantization level. The second data processing parameter may be one of a second model structure, a second model type, a second layer configuration, a second input dimension, a second output dimension, or a second quantization level.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A illustrates exemplary features associated with adapting an AI model based on a capability change.

FIG. 2B illustrates an example for adapting an AI model (e.g., based on a capability change).

FIG. 3 illustrates exemplary features associated with changing an AI model based on a context change.

### DETAILED DESCRIPTION

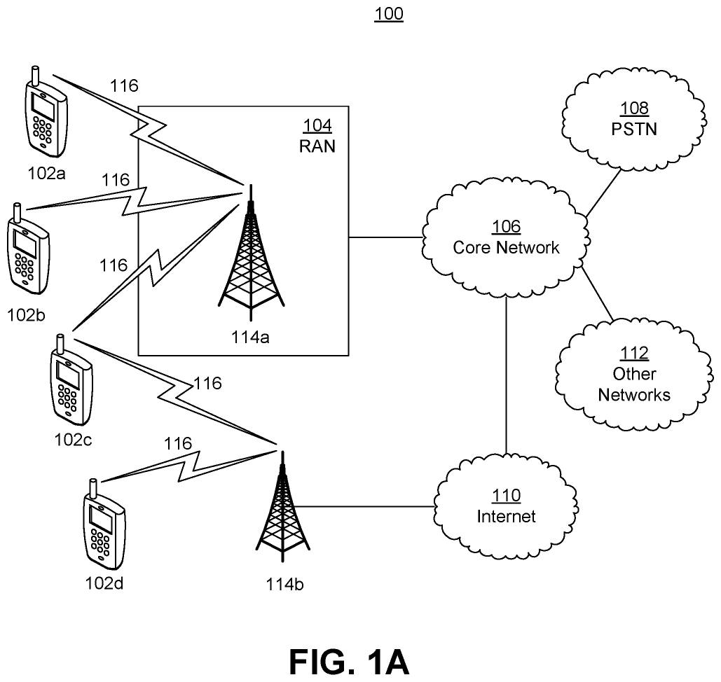

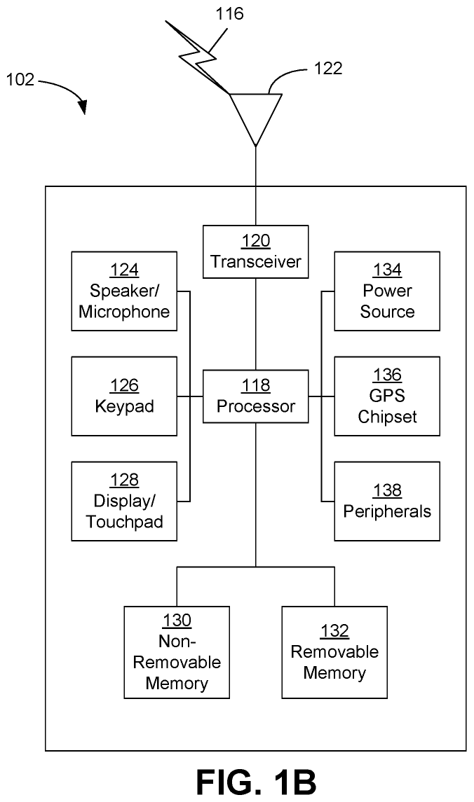

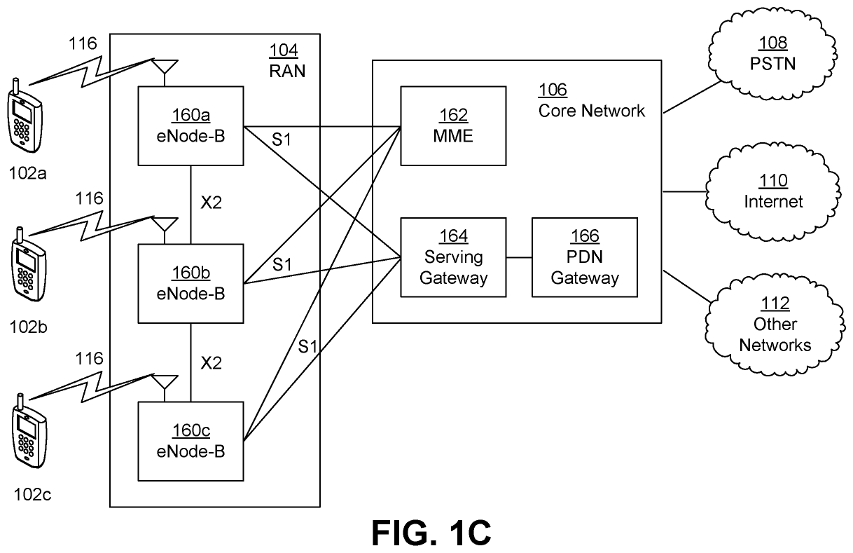

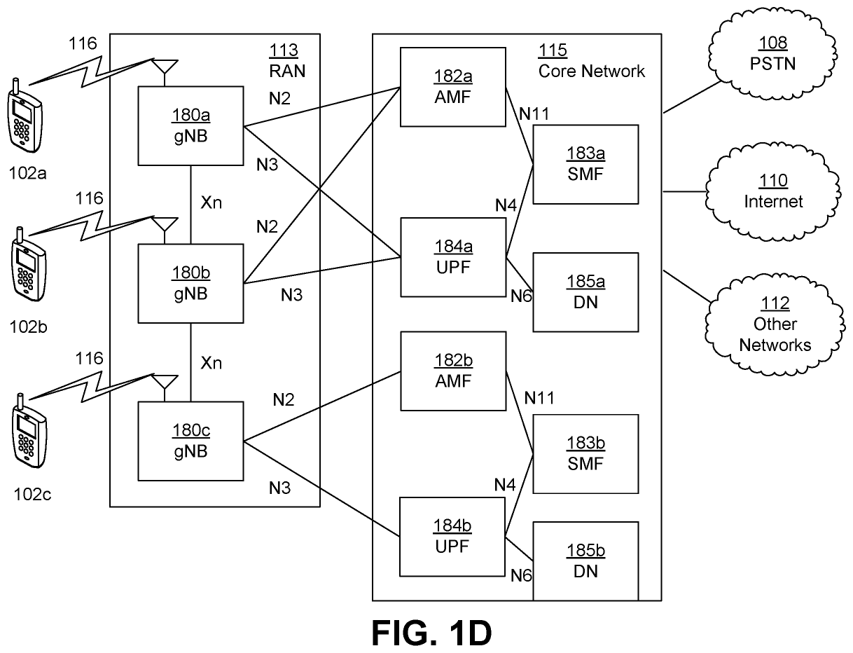

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other

RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for modifying, adapting and/or changing the processing associated with an artificial intelligence (AI) component in a node (e.g., a wireless transmit/receive unit (WTRU)). The WTRU may change the applicable AI model characteristics for a given wireless-related function according to at least one of the following.

The WTRU may change applicable AI model characteristics using WTRU-autonomous methods for adaptive AI processing. The WTRU may initiate a change of an applicable AI model based on one or more selection criteria, for example, when the WTRU detects (e.g., upon a detection of) a change in the execution environment (or context) of the AI component. For example, the execution environment (or context) of the AI component may include a model context.

Such selection criteria may include detecting one or more changes in one or more of the following: channel (PDSCH)/link measurements, device capabilities, a position (e.g., a position determined based on one or more of reference signals, a cell/cell ID, a base station (e.g., a gNodeB), a logical area, a geographical area, etc.), a state of the WTRU related to its operation in the wireless system (e.g., a power saving state, a connectivity state, or the likes), a required inference accuracy or a configuration aspect.

The WTRU may initiate a change in the execution of an applicable AI component/AI model based on (e.g., upon) a detection of a change in the execution environment (or context) of the AI component. Such change may include executing a model (e.g., the AI model the WTRU is using) differently. For example, the WTRU may execute the model using one or more of a different structure, a different type, a different runtime environment and/or different parameters thereof, a different number of neural network layers, a different model layer configuration, a different model input/output dimension, or different learned parameters of the model including one or more of model weights, or model quantization of the likes.

The WTRU may change one or more of the applicable AI model characteristics using network (NW)-controlled methods for an AI component adaptation. The WTRU may receive signaling that configures one or more criteria for the change and/or adaptation of the AI component, for example, with corresponding parameters and/or with another model (e.g., a second AI model). The WTRU may indicate the change, adaptation and/or activation of another model (e.g., a second AI model) to the network, for example, explicitly or implicitly.

Systems, methods, and instrumentalities are described herein for modifying, adapting and/or changing the processing associated with an artificial intelligence (AI) component in a node (e.g., a wireless transmit/receive unit (WTRU), which may be used as an example of a node).

A WTRU may adapt or change an AI model, e.g., based on changes in computational resources, changes in a power status, etc. For example, a WTRU may determine feedback information (e.g., first CSI feedback information which may be used as an example) using a first data processing model. The WTRU may transmit an indication of the determined first CSI feedback information (e.g., to another node, which may be a base station). The WTRU may determine that a triggering condition associated with use of the first data processing model has been met. The WTRU may determine, based on the determination that the triggering condition has been met, a data processing model to use to determine second CSI feedback information, where the data processing model is different than the first data processing model.

If the triggering condition that has been met is that a change in a processing capability associated with the WTRU exceeds a first threshold, and the change in the processing capability associated with the WTRU is less than a second threshold, the WTRU determines that the data processing model to use to determine the second CSI feedback information is a second data processing model. If the triggering condition that has been met is that the change in the processing capability associated with the WTRU exceeds the second threshold, the WTRU determines that the data processing model to use to determine the second CSI feedback information is a third data processing model. The WTRU may generate a number of HARQ NACKs over a preconfigured amount of time. If the triggering condition that has been met is that the number of HARQ NACKs generated over the preconfigured amount of time is greater than a value, the WTRU determines that the data processing model to use to determine the second CSI feedback information is a fourth data processing model. If the triggering condition that has been met is that the WTRU changes from using a first BWP to using a second BWP, the WTRU determines that the data processing model to use to determine the second CSI feedback information is a fifth data processing model. The WTRU may measure one or more of reference signals received power (RSRP), reference signal received quality (RSRQ), or signal-to-interference-plus-noise ratio (SINR). If the triggering condition that has been met is that a result of the measurement changes from a first range to a second range, the WTRU determines that the data processing model to use to determine the second CSI feedback information is a sixth data processing model. If the triggering condition that has been met is that the WTRU changes from a first location to a second location, the WTRU determines that the data processing model to use to determine the second CSI feedback information is a seventh data processing model. If the triggering condition that has been met is that the WTRU uses a second multiple-input multiple output (MIMO) configuration instead of a first MIMO configuration, the WTRU determines that the data processing model to use to determine the second CSI feedback information is an eighth data processing model. If the triggering condition that has been met is that the WTRU uses a second (RS) configuration instead of a first RS configuration, the WTRU determines that the data processing model to use to determine the second CSI feedback information is a ninth data processing model.

The WTRU may transmit an indication of the determined data processing model (e.g., to another node, which may be the base station). The indication of the determined data processing model may comprise one or more of a reason for the usage of the determined data processing model, a type of adaptation to the first data processing model, or an extent of the adaptation to the first data processing model. The WTRU may determine the second CSI feedback information using the determined data processing model. The WTRU may transmit an indication of the determined second CSI feedback information (e.g., to another node, which may be the base station).

The WTRU may determine the second data processing model by adapting the first data processing model (e.g., for the case where the triggering condition that has been met is that a change in a processing capability associated with the WTRU exceeds a first threshold, and the change in the processing capability associated with the WTRU is less than a second threshold). The WTRU may determine the third data processing model by switching the first data processing model to the third data processing model (e.g., for the case where the triggering condition that has been met is that the change in the processing capability associated with the WTRU exceeds the second threshold).

A data processing model may be one of an artificial intelligence (AI) model, a machine learning (ML) model, or a deep learning (DL) model. The change in the processing capability associated with the WTRU may comprise a change in a processing power allocated for using the first data processing model to generate CSI feedback information.

The first data processing model may comprise a first data processing parameter and the second data processing model may comprise a second data processing parameter. The first data processing parameter may be one of: a first model structure, a first model type, a first layer configuration, a first input dimension, a first output dimension, or a first quantization level. The second data processing parameter may be one of a second model structure, a second model type, a second layer configuration, a second input dimension, a second output dimension, or a second quantization level.

Adapting processing associated with AI component(s) may be enabled using contextual AI models. Contextual models may include AI models that may be associated with specific contexts (e.g., specific to WTRU measurements, logical area gNB/TRP, dynamic WTRU capability related to AI processing, radio resource configuration etc.)

Model adaptation techniques may include one or more of a model selection, a model structure (layer-wise, neuron-wise, connectivity, matrix rank etc.), a model input/output adaptation, a model quantization etc.

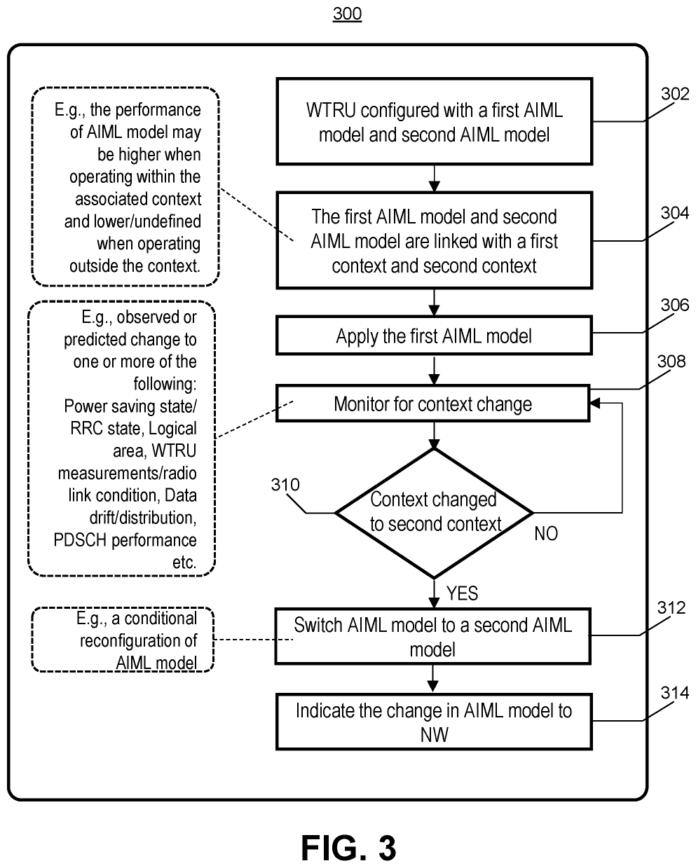

The WTRU may adapt AI processing using an adaptation triggered based on a change in context, for example, to improve AI model performance (e.g., inference accuracy). FIG. 3 illustrates exemplary features associated with changing an AI model based on a context change.

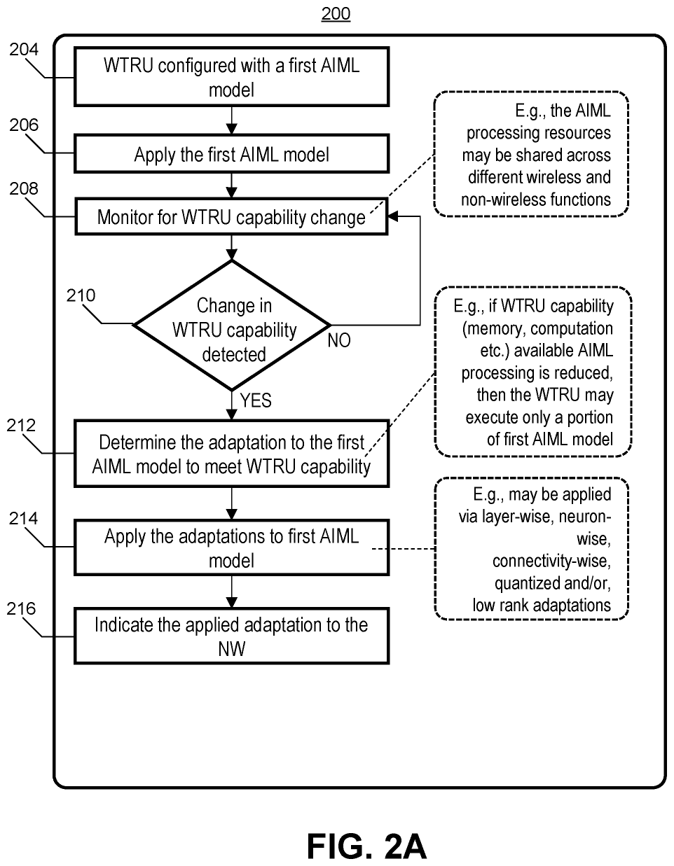

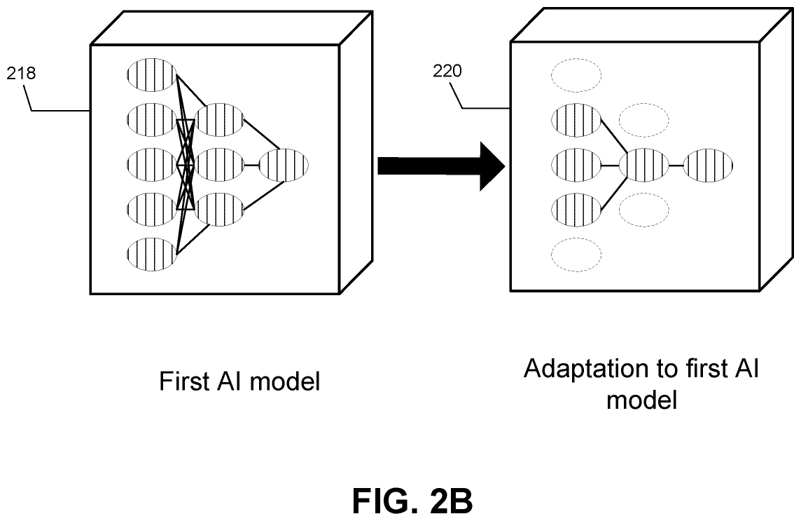

The WTRU may adapt AI processing using an adaptation triggered based on a change in WTRU capabilities, for example, to tradeoff AI model performance to handle variable WTRU capability. FIG. 2A illustrates exemplary features associated with adapting an AI model based on a capability change.

The WTRU may adapt AI processing to tradeoff AI model performance, for example, to achieve an objective with regards to one of more of the following: power consumption, memory, latency, overhead or processing complexity.

Adaptive processing of AI components may be based on preconfigured rules. The adaptive processing of AI components may enable tradeoff between power consumption, latency, inference accuracy, processing power (e.g., GPU sharing between AI functions within wireless and/or application functions) and resource overhead.

Processing associated with an AI component in a device may be adapted, for example, using one or more techniques herein. The device may be any node in a wireless network such as a gNB, a WTRU, or the likes. Although one or more techniques herein may be described in terms of a WTRU, the one or more techniques herein are applicable to other nodes in a wireless network.

A WTRU may be configured with one of more AI component(s). Such AI component may perform a wireless-related function. An AI component may include one or more available AI model(s). An available model may be a model stored in the WTRU or stored in the network available for a transfer to the WTRU.

An AI model selection may be autonomously performed, for example, by a WTRU.

The WTRU may be configured with a first AI model (e.g., as shown in 204 of FIG. 2A and 302 of FIG. 3) and a second AI model (e.g., as shown in 302 of FIG. 3).

The WTRU may be configured with one (or more) selection criteria associated with the AI models (e.g., the first AI model and the second AI model). A change in an AI model context may occur. The first AI model and second AI model may be trained using different contexts. The first AI model may be trained using a first context, and the second AI model may be trained using a second context. The selection criteria may be associated with the context of an AI model (e.g., the context used to train the AI model, including, for example, the first context and the second context)). The WTRU may determine based on one or more of the selection criteria that the context of the first AI model (the first context) may be no longer suitable for the changed AI model context. The first context may be a WTRU measurement value (RSRP, RSRQ, SINR etc.) within a first range and a second context may be a WTRU measurement value within a second range. The first context may be a first WTRU capability (e.g., one or more of memory, available processing power, etc.) within a first range and a second context may be a second WTRU capability (e.g., one or more of memory, available processing power, etc.) within a second range. The first context may be a first logical area (gNB, cell, TRP etc.) and a second context may be a second logical area (gNB, cell, TRP etc.). The first context may be a first RS configuration and a second context may be a second RS configuration.

The WTRU may perform one or more of the following: the WTRU may use a first AI model for the AI component; the WTRU may monitor (e.g., measure), for example, as shown in 208 of FIG. 2A and/or in 308 of FIG. 3 and evaluate the selection criteria, for example, as shown in 210 of FIG. 2A and in 310 of FIG. 3; upon detecting a condition that matches a selection criterion (e.g., a change of context), the WTRU may determine that a second AI model may satisfy the selection criteria, for example, as shown in 210 of FIG. 2A and/or in 310 of FIG. 3; the WTRU may replace (e.g., stop using) the first AI model with (e.g., initialize and/or start execution of) the second AI model, to apply the second AI model for the AI component; the WTRU may initiate a procedure (e.g., a transmission of an indication) that may implicitly or explicitly indicate the change in AI model to another node in the wireless network, for example, as shown in 216 of FIG. 2A and in 314 of FIG. 3.

An AI model adaptation may be autonomously performed, for example, by a WTRU.

A WTRU may be configured to perform a wireless-related function, for example, using an AI component.

The WTRU may be configured with an AI model for the AI component. The WTRU may adapt the execution of a model (e.g., the AI model). For example, the WTRU may select a portion of the AI model based on a condition (e.g., a preconfigured condition). The condition may include a change in a WTRU context and/or a WTRU capability.

The WTRU may perform the wireless-related function using the execution adaptation (e.g., the selected portion) of the AI model. The adaptation to the execution of the AI model (e.g., by selecting a portion of the model) may include skipping one or more layers and//or neurons, adapting input/output dimension(s), applying preconfigured quantization to the AI model or parts thereof etc., for example, as shown in FIG. 2B.

The WTRU may transmit an implicit or explicit indication to indicate the adaptation to the execution of the AI model (e.g., the partial AI model execution).

A WTRU configured with a first AI model and a second AI model. The first AI model and the second AI model may differ in one or more of the following: model structure, model type, layer configuration, mode input/output dimension, learned parameters of the model including model weights, model quantization etc. The first AI model and the second AI model may be associated with a selection criterion. For example, the selection criterion (e.g., the rules for selection of AI model) may be associated with a power saving state of the WTRU.

The first AI model and the second AI model may be configured with different characteristics such that the inference accuracy associated with the second AI model may be lower than the first AI model, and/or the first AI model and the second AI model may be configured with the different characteristics such that the power consumption associated with the second AI model may be lower than the first AI model. For example, the second AI model may be configured such that the number of operations to perform inference may be less than the first AI model.

The WTRU may apply the first AI model for a wireless function (e.g., CSI feedback determination and/or compression), for example, based on (e.g., upon) a trigger condition. The trigger condition may be preconfigured, received in the configuration information along with an indication of an AI model, or received separately from the configuration information indicating the AI model. For example, the WTRU may apply the first AI model for a wireless function when the WTRU transitions to a power saving state. The WTRU may apply the first AI model for a wireless function when the WTRU transitions from a first power saving state to a second power saving state.

The WTRU may activate (e.g., autonomously activate) the second AI model and apply the second AI model for the wireless function.

The WTRU may indicate the activation of the second AI model to the network, for example, either explicitly or implicitly.

The following description may be for exemplary purposes and does not limit in any way the applicability of the methods described herein to a specific wireless technology, to a specific communication technology and/or to other technologies, when applicable. The term network in this disclosure may refer to one or more gNBs which in turn may be associated with one or more Transmission/Reception Points (TRPs), or to any other physical and/or logical node in the radio access network.

Artificial intelligence (AI) may include the behavior(s) exhibited by machines. Such behavior(s) may include e.g., mimicking cognitive functions to sense, reason, adapt and act.

Machine learning (ML) may refer to type of algorithms that solve a problem based on learning through experience (data), without explicitly being programmed (configuring set of rules). Machine learning may be considered as a subset of AI. An ML model may include, for example, a linear regression model. Different machine learning paradigms may be envisioned based on the nature of data or feedback available to the learning algorithm. For example, a supervised learning approach may involve learning a function that maps input to an output based on labeled training example, wherein a (e.g., each) training example may be a pair including an input and the corresponding output. For example, unsupervised learning approach may involve detecting patterns in the data with no pre-existing labels. For example, reinforcement learning approach may involve performing a sequence of actions in an environment to maximize the cumulative reward. In some examples, it may be possible to apply machine learning algorithms using a combination or interpolation of the approaches herein. For example, semi-supervised learning approach may use a combination of a small amount of labeled data with a large amount of unlabeled data during training. In this regard semi-supervised learning may fall between unsupervised learning (e.g., with no labeled training data) and supervised learning (e.g., with only labeled training data).

Deep learning (DL) may include machine learning algorithms that employ artificial neural networks (e.g., DNNs) which were inspired from biological systems. The Deep Neural Networks (DNNs) may be a special class of machine learning models inspired human brain wherein the input may be linearly transformed and pass-through non-linear activation function multiple times. DNNs may include multiple layers where a (e.g., each) layer may include a linear transformation and a given non-linear activation function. The DNNs may be trained using the training data via back-propagation algorithm. DNNs may show state-of-the-art performance in variety of domains, e.g., speech, vision, natural language etc. and for various machine learning settings (e.g., supervised, un-supervised, and/or semi-supervised). In examples, an AI component may have a capability of or may refer to realization of behaviors and/or conformance to requirements by learning based on data, for example, without an explicit configuration of a sequence of steps of actions. An AI component may enable learning complex behaviors (e.g., behaviors which might be difficult to specify and/or implement when using legacy methods).

Auto-encoders may include specific class of DNNs that arise in context of un-supervised machine learning setting wherein the high-dimensional data may be non-linearly transformed to a lower dimensional latent vector using the DNN based encoder and the lower dimensional latent vector may be then used to re-produce the high-dimensional data using a non-linear decoder. The encoder may be represented as E (x; Wₑ) where x may be the high-dimensional data and Wₑ may represent the parameters of the encoder. The decoder may be represented as D (z; W_{d}) where z may be the low-dimensional latent representation and W_{d} may represent the parameters of the encoder. For example, using training data {x₁, . . . , x_{N}} the auto-encoder may be trained by solving the following optimization problem

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above problem may be approximately solved using a backpropagation algorithm. The trained encoder E (x; Wₑ^{tr}) may be used to compress the high-dimensional data and trained decoder D (z; W_{d}^{tr}) may be used to decompress the latent representation.

The terms Artificial Intelligence (AI), Machine Learning (ML), Deep Learning (DL), DNNs may be used interchangeably. The terms AI model, ML model, AIML model, DL model may be used interchangeably. A data processing model may be an AL model, an ML model, an AIML model, and/or a DL model. In one or more examples herein, an AL model, an ML model, an AIML model, and/or a DL model may be used as an example of a data processing model. Methods described herein may be exemplified based on learning in wireless communication systems. The methods may be not limited to such scenarios, systems and services and may be applicable to any type of transmissions, communication systems and/or services etc.

Recurrent Neural Networks (RNNs) may be algorithms that may be effective in modeling sequential data. RNNs contain internal memory that enables the model to remember previous inputs as well as current inputs to help sequence modelling. The output for a (e.g., any) step within the neural network may not only depend on the current input, but also on the output generated at previous steps. They can exemplify how a neural network may track evolving conditions for a given task (e.g., in terms of tracking the impact of the changes in one or more of the following: channel/radio, change in latency, bitrate, jitter), for example, for the purpose of determination on how to apply QoS treatment on a per packet basis for a given flow, or the likes.

Channel State Information (CSI) reporting may be performed. A WTRU may be configured to determine and/or report CSI.

CSI (e.g., CSI feedback information), which may include at least one of the following: channel quality index (CQI), rank indicator (RI), precoding matrix index (PMI), an L1 channel measurement (e.g., RSRP such as L1-RSRP, or SINR), CSI-RS resource indicator (CRI), SS/physical broadcast channel (PBCH) block resource indicator (SSBRI), layer indicator (LI) and/or any other measurement quantity measured by the WTRU from the configured reference signals (e.g. CSI-RS or synchronization signal (SS)/PBCH block or any other reference signal).

A WTRU may be configured to report the CSI (e.g., by sending an indication of CSI feedback information) through the uplink control channel on PUCCH, or per the gNBs' request on an UL PUSCH grant. Depending on the configuration, CSI-RS may cover the full bandwidth of a BandWidth Part (BWP) or a fraction of it. Within the CSI-RS bandwidth, CSI-RS may be configured in a (e.g., each) PRB or every other PRB. In the time domain, CSI-RS resources may be configured to be periodic, semi-persistent, or aperiodic. Semi-persistent CSI-RS may be similar to periodic CSI-RS, except that the resource may be (de)-activated by MAC CEs; and the WTRU may report related measurements when (e.g., only when) the resource may be activated. For aperiodic CSI-RS, the WTRU may be triggered to report measured CSI-RS on PUSCH by a request in a DCI. Periodic reports may be carried over the PUCCH, while semi-persistent reports may be carried on PUCCH or PUSCH. The reported CSI may be used by the scheduler when allocating optimal resource blocks based on one or more of the following: channel's time-frequency selectivity, determining precoding matrices, beams, transmission mode and selecting suitable MCSs. In examples, the reliability, accuracy, and timeliness of WTRU CSI reports may meet URLLC service requirements (e.g. may be critical to meeting URLLC service requirements).

Types of processing may include rule-based processing and AI processing.

In some approaches, the term ‘rule-based’ processing may refer to specified WTRU behavior and/or requirements explicitly defined in the form of procedural text, signaling syntax or the likes. Rule based processing may refer to processing (e.g., any processing) based on legacy algorithms (e.g., algorithms that may be essentially non-AI based). For example, LCP procedure may be defined as a sequence of procedural steps. In some examples, an entity that performs processing (e.g., AI processing) may be referred as a rule-based component.

In examples, AI processing may include specified WTRU behavior and/or processing or parts thereof that may be learned based on training using data. AI processing may involve one or more of classical machine learning techniques and/or deep learning techniques. AI processing may apply one or more AI model architectures to perform one or more of classification, prediction, pattern recognition, dimensionality reduction, estimation, interpolation, clustering, regression, compression, recommendation, approximation of an arbitrary function etc. AI processing may utilize one or more of supervised, unsupervised, reinforcement learning or a variant thereof. In examples, an AI model applying AI processing may be trained by various techniques including one or more of offline training, online training, online refinement, or the likes. For example, such training may be performed locally on the WTRU, partially on the WTRU or downloaded from the network. In examples, an entity that performs AI processing may be referred as AI component or an AI filter. In some examples, AI processing may be performed using a program that determines a wireless function related parameter.

The extent of AI within the protocol may be introduced and/or controlled.

A protocol layer may be defined using one or more processing blocks. A (e.g., each) processing block may have defined/specified input and outputs. Herein the processing block may be implemented as rule-based steps or using an AI component. In some examples, the processing block may be dynamically configured to be rule-based, or AI component based. The AI component behavior may be affected by training data. The behavior of the AI component and/or its parameterization may be impacted by one or more of the following: NW configuration, WTRU implementation, application configuration, or a default/reference AI model configuration. The AI component may be configurable to achieve different levels of performance e.g., configurable processing complexity/accuracy/power consumption/granularity etc.

A function associated with a protocol layer may be realized by means of one or cascading of more than one processing blocks, wherein a (e.g., each) processing block may implement a specific sub-task. In some realizations, the cascading may include piecing together various processing blocks in a sort of interlocking (‘Lego’ like) arbitrary patterns. For example, the processing blocks may be arranged in sequence, wherein output of one processing block may be an input to another processing block. For example, the processing block may be arranged in parallel, wherein the output of one processing block may be input to two or more processing blocks. For example, the output of two or more processing blocks may be input to one processing block. For example, the input of a processing block at time T may be an output of the same or different processing block from T−n. The values of n may be preconfigured (e.g., a default may be 1 or previous time instance).

Cascading of processing blocks may provide a framework to introduce learning-based algorithms into RAN protocols, for example, without compromising the interoperability, conforming to a standardized signaling and behavior, while at the same time achieving benefits of machine learning.

Such framework may enable the learning-based functions to co-exist with rule-based counterparts e.g., to enable specific specialized tasks and/or to achieve a phased introduction of machine learning into the system. It may be possible to configure how much AI may be used in the protocol, for example, based on a maturity of machine learning model or an availability of training data etc.

Cascading of processing blocks may enable flexible partitioning of WTRU processing between various flows (e.g., dedicated processing blocks for high priority vs shared processing blocks for others high performant processing blocks (e.g., better accuracy/granularity) for critical flows vs acceptable performant processing blocks for best effort etc.

Cascading of processing blocks may enable flexible partitioning of WTRU hardware processing between various protocol functions. For example, a WTRU may have limited hardware resources to store/train/perform inference using AI components. By cascading different processing blocks with different characteristics (e.g., large AI component, small AI component, rule-based component etc.), it may be possible to realize specific RAN functions given a WTRU capability. Such partitioning may be dynamic based on several factors including one or more of the active flows (& their QoS), WTRU power saving state etc.

Cascading of processing blocks may enable on-the-fly dynamic function realization. For example, a (e.g., each) processing block may be used as (e.g., equivalent to) a low-level representation of a sub-task. The cascading of processing block may be used to realize higher level of abstraction/function.

In some approaches, the WTRU may determine based on the INPUT, OUTPUT parameters associated with an AI filter what may be the entry point of the AI filter within the processing chain. For example, if one of the inputs may be “RLC PDU” then the WTRU may determine that the AI filter operates at the Service Access Point (SAP) between the RLC and the MAC layer or, more specifically, corresponds to the entry point of the MAC multiplexing function. For example, if one of the inputs may be a set of applicable logical channels, or type thereof, the WTRU may determine that a subset (e.g., only a subset) of the SAPs may be applicable for the concerned filter. For example, if one of the outputs may be a MAC PDU, the WTRU may determine that the AI filter operates at the SAP between the MAC and the PHY layer or, more specifically, corresponds to the exit point of the MAC multiplexing function. For example, if additionally, one of the inputs includes HARQ processing configuration, the WTRU may determine that the AI filter additionally include HARQ processing functions.

In some approaches, a WTRU may be configured with an AI component communicatively linked to a remote AI component over a wireless channel. In examples, the AI component at the WTRU may correspond to an encoder function and the remote AI component may be a decoder function. In some examples, the AI component at the WTRU may correspond to a decoder function and the remote AI component may be an encoder function. In examples, the AI component may be ML model. The ML model may include at least in part deep neural network. In one example realization, the encoder and decoder herein may be coupled to form an autoencoder architecture. In examples, the AI component may be located in the WTRU and the remote AI component may be located in the network. For example, such encoder/decoder architecture may be applied for functions such as CSI feedback determination and/or compression.

In one or more examples below the terms AI model, AI filter and AI component may be used interchangeably.

AI/ML may be used in a terminal device with autonomous or NW-controlled behavior, or over the air interface.

Artificial Intelligence (AI), including Machine Learning (ML), may be applied to wireless transmitters and/or to wireless receivers. AI/ML may be used to improve one or more specific aspect(s), function(s) or protocol(s) operation of a wireless node e.g., either as a local optimization within a node and/or as part of a function, or procedure over the air interface (AI-AI). One or more techniques herein may be used to support artificial intelligence in a communication system, or within a communication protocol stack. In examples, a data processing model (e.g., an AI/ML/DL model) may be tailored to one or more specific aspect(s), function(s) or protocol(s) operation of a wireless node, the complexity of the data processing model may be reduced, the performance of the data processing model may be improved, and the resources required to process the model (e.g., processing power, memory requirements etc) may be reduced.

A design of a preferred AI/ML model may be based on one or more tradeoffs.

There may be a practical tradeoff between the complexity of an AI model and its applicability to a given wireless context for the desired minimal performance requirements: for example, a preferred model may perform at or above (e.g., consistently at or above) the minimal required performance but may require a large data set for training, a substantial effort to find a suitable model and/or hyper parameters, increased convergence time, a large number of layers, a considerable amount of device storage and/or excessive processing resources to perform its tasks, very high latency to perform inference etc.

A tradeoff between AI/ML model complexity and constant performance may be taken into account.

AI/ML for wireless may maintain the performance of AI models over a broad range of possible operational contexts, where such contexts may vary as a function of at least one of the WTRU/gNB implementation/hardware characteristics and the wireless medium, as a function of e.g., the density/location of reference signals, the location of transmitter antennas, the resources in time, frequency or space, the transmission parameters, any configurable aspects, the cell deployments, and/or any aspect/component that may introduce non-linear impacts to the processing of a signal and/or transmission.

A rule-based processing may the lack of flexibility (for example, the flexibility that one or more techniques may offer).

Legacy rule-based processing may be quite limited in terms of adaptation to tradeoff between power consumption, processing complexity, latency, storage requirements etc. For example, rule-based processing typical strategy to save power may be adaptation of duty cycle of processing. Applying the processing less frequently or not performing the operation. For example, CSI transmission may be configured to occur on different periodicities, wherein a longer periodicity may enable power efficient operation than a shorter period. The options to perform a (e.g., any) fine-grained adaptation may be limited.

Adaptive processing for AI based wireless systems may be performed.

The techniques described herein may be applicable, without limitation to, any communication link that include two (point-to-point) or more (point-to-multipoint) communication devices (e.g., 3GPP LTE Uu, 3GPP NR Uu, 3GPP Sidelink, IEEE Wi-Fi technologies including protocols for wireless air interfaces and device-to-device communications with or without relaying capabilities).

Adapting processing associated with AI components may be enabled using one or more techniques herein.

A device (e.g., a terminal device) may detect a change in the operational environment and/or context in which the AI/ML (e.g., AI/ML component) may be executing one or more of its tasks. The device may autonomously adapt the AI/ML component, possibly in relation to such detection.

Such adaptation may herein include (re)selecting an AI model for executing a given task and/or changing (e.g., altering) a characteristic/property/parameterization of an AI model. The AI model may be associated with operation(s) (e.g., wireless function(s)) that affect one of more of: WTRU behavior(s), procedural aspects, protocol aspects, signaling aspects, including triggers, functions that determine resources, bits to be transmitted over the air or the likes.

A WTRU may be configured to perform such adaption dynamically. Such adaptation may be used to maintain an acceptable level of performance (e.g., an acceptable level of performance in relation with specified requirements) for the wireless function(s) given the dynamically changing wireless environment. Such adaptation may be useful to improve the performance for the operation(s) (e.g., wireless function(s)), given the dynamically changing wireless environment. A WTRU may be configured to select/(re)configure an AI model, for example, to meet the target performance (e.g., inference accuracy for the given task) with considerations for other performance aspects. The other performance aspects may include reducing (e.g., minimizing) one or more of power consumption, storage/memory requirement(s), inference latency, processing power/complexity, or the like. The WTRU may be configured with or may learn, through training a data processing model, performance information (e.g., one or more of power consumption, storage/memory requirement(s), inference latency, processing power/complexity, or the like) of the data processing model or an adaptation of the data processing model.

In some examples, a WTRU may be configured to support an adaptation of AI/ML processing to enable a tradeoff between performance (e.g., inference accuracy for the given task) and at least one of the following: power consumption, storage/memory requirement(s), inference latency, processing power/complexity or the likes.

A network node may determine, for example, using one or more techniques herein, that a WTRU has performed such adaptation, and/or that a change in the execution or performance of an AI component may have occurred (e.g., when the function(s) using an AI/ML component may impact the overall system performance and/or impact the ability of a network node to optimize the overall terminal device and/or system performance and/or apply a suitable peer AI/ML component).

An AI component may be associated with a context.

A WTRU may be configured with one or a plurality of AI models. A (each) AI model may be associated with a context. A context may include contextual information that indicates circumstances in which a data processing model is trained and/or operates. Contextual information may include a set of parameters and/or measurements.

For example, a context may refer to a set of conditions under (and/or during) which the performance of the AI model may be expected to be above a threshold. Such threshold may be a configuration aspect of a device (e.g., the WTRU).

For example, a context may refer to a distribution of training data for which the AI model may be trained, validated and/or tested.

For example, a context may refer to the set of conditions under which the AI model's performance may be expected to be higher than the performance of the same AI model outside the context. For example, in some cases, the performance of AI model may be undefined outside of the context with which the AI model may be associated. A wireless function may be expected to operate under a wide range of contexts, and an (e.g., each) AI model may be associated with a specific subset of contexts (e.g., a respective subset of context).

A contextual AI model may include an AI model that may be associated with a specific context. The inference accuracy of a contextual model (e.g., the contextual AI model) may depend on the context under which the model may be executed. One or more of the size, training time, inference latency, complexity, and/or power consumption, associated with a contextual AI model may be lower than that of an AI model that may be expected to perform under some or all the contexts.

The context may be determined (e.g., associated and/or defined) using one or a combination of the following.

The context may be determined (e.g., associated and/or defined) using one or more characteristics associated with a radio link (e.g., observed or predicted characteristics):

The one or more characteristics associated with a radio link may include a characteristic associated with WTRU measurements (e.g., one or more of RSRP, RSRQ, SINR values or a range thereof). The characteristic associated with WTRU measurements may include a metric defined and/or derived based on the WTRU measurements. The characteristic associated with the WTRU measurements may be based on L1 or L3 measurements.

The one or more characteristics associated with a radio link may include a characteristic/property associated with a channel. The characteristic/property associated with a channel may be determined (e.g., abstracted) by a logical identity (e.g., Umi, Uma, indoor, outdoor etc.)), or may be determined by a configuration/indication distinguishing feature of the channel model and/or the channel type (e.g., Umi, Uma, indoor, outdoor etc.).

The one or more characteristics associated with a radio link may include an arrangement of wireless resources in time and/or frequency domain of the WTRU's configuration (e.g., one or more of a subset of physical resource blocks (PRBs), bandwidth part (BWP), SCell, PSCell, a multi-carrier configuration, or the likes).

The one or more characteristics associated with a radio link may include a specific frequency range (e.g., FR1, FR2, FR3 etc.).

The one or more characteristics associated with a radio link may include a numerology, (e.g., cyclic prefix (CP), sub carrier spacing (SCS), transmission time interval (TTI), etc.)

The one or more characteristics associated with a radio link may include a duplexing aspect (e.g., different models for time-division duplexing (TDD) vs frequency-division duplexing (FDD), different models for different TDD configuration etc.).

The one or more characteristics associated with a radio link may include a spatial aspect (e.g., associated with beams or logical identity thereof, AI model applicable for SSB beams may be different from channel state information (CSI)-reference signal (RS) beams).

The one or more characteristics associated with a radio link may include a reference signal configuration (e.g., a type of reference signal, for example, one or more of a synchronization signal blocks (SSB), CSI-RS, tracking reference signal (e.g., TRS), density, periodicity etc.). A presence or absence of a specific RS transmission may indicate a change in the context.

The one or more characteristics associated with a radio link may include a status associated with a radio link condition (e.g., an in-sync or out-of-synch status, a detection of radio link failure (RLF), a detection of beam failure, etc.).

The context may be determined (e.g., associated and/or defined) using one or more characteristics associated with a connectivity state (e.g., observed or predicted).

The one or more characteristics associated with a connectivity state may include a WTRU mobility state (or a speed of the WTRU) or measured doppler spread.

The one or more characteristics associated with a connectivity state may include a mobility and/or a logical area. For example, an AI model may be (e.g., configured to be) associated with a context. The context may include one or more of a cell, a cell ID, a sequence association with SSB or CSI-RS or positioning RS, a TRP, a gNB, a central unit (CU), a traffic area, a routing area or any logical area like a radio access network (RAN) area or even a geographical area including a given position within such.

The one or more characteristics associated with a connectivity state may include a WTRU protocol state/status, for example, one or more of the following: an RRC state (e.g., IDLE, INACTIVE, CONNECTED etc.), an L2 protocol state/configuration, protocol timers, counters, or the like.

The one or more characteristics associated with a connectivity state may include a higher layer connectivity to a network analytics function. For example, an AI model may be associated with a context. The context may be a logical connection to a core network component such as a Management Data Analytics Function (MDAF), an Access and Mobility Management Function (AMF), a NW Data Analytics Function (NWDAF) or a similar function. Such function may provide data and/or enable training for the AI component for the given context.

The one or more characteristics associated with a connectivity state may include a Packet Data Network (PDN) connectivity. For example, an AI model may be associated with a context. The context may be a logical connection to a core network component such as PDN connection. For example, a change in PDN connection may correspond to a change of context of the concerned AI component. For example, an AI component that manages QoS differentiation and/or packet classification in the WTRU may be associated to a context related to the core network management for service level agreements or the likes.

The context may be determined (e.g., associated and/or defined) using one or more characteristics associated with an operational configuration and/or state (e.g., observed or predicted).

The one or more characteristics associated with an operational configuration and/or state may include an RRC configuration. For example, a WTRU may be configured with an association between a AI model context with a RRC configuration. Based on (e.g., upon receiving) a radio resource control (RRC) reconfiguration, the WTRU may assume that the current context (e.g., the existing context) may be no longer applicable. The WTRU may be configured to apply a different (e.g., new) context based on the RRC configuration.

The one or more characteristics associated with an operational configuration and/or state may include a type of link and/or air interface (e.g., Uu, Sidelink, Uplink, Downlink or Backhaul).

The one or more characteristics associated with an operational configuration and/or state may include a specific type of access method (e.g., a licensed, or unlicensed spectrum).

The one or more characteristics associated with an operational configuration and/or state may include a specific type of resource allocation method (e.g., sidelink resource mode 1, network scheduled, sidelink resource mode 2, WTRU-selected, or the likes).

The one or more characteristics associated with an operational configuration and/or state may include a scheduling aspect (e.g., a property of scheduling grant or a configured grant). The property of a scheduling grant or a configured grant may include a size of allocated resource(s), available resource(s) for transmission (e.g., a feedback transmission possibly after allocation for other feedback or data transmissions), modulation and coding scheme (MCS), radio network identifier (RNTI) etc.

The one or more characteristics associated with an operational configuration and/or state may include a characteristic of transmission (e.g., physical channels, a priority of transmission, an RNTI associated with transmission etc.)

The one or more characteristics associated with an operational configuration and/or state may include a function of a WTRU power saving state (e.g., discontinuous reception (DRX), Active etc. or a combination thereof)

The one or more characteristics associated with an operational configuration and/or state may include a characteristic of a bearer configuration. For example, a characteristic of a bearer configuration may include specific QoS characteristics/requirements/configuration of radio bearers (e.g., eMBB, URLLC, mMTC or a combination thereof), Logical channel(s) or a group thereof.

The one or more characteristics associated with an operational configuration and/or state may include a property of feedback (e.g., a latency for feedback, reporting quantities, a report type (e.g., periodic, semi-persistent, aperiodic, etc.)).

The one or more characteristics associated with an operational configuration and/or state may include a MIMO configuration (e.g., a number of antenna ports, a Quasi Co-Location (QCL) configuration, spatial multiplexing, a transmit diversity etc.). An aspect of ongoing data transmissions may include one or more of the following: traffic patterns, an outcome of an logical channel prioritization (LCP) procedure, a prioritization between flows, an arrival of traffic at high priority flow or the likes. In examples, the WTRU may be configured with a mapping restriction between an AI Model and the applicable logical channels (LCHs).

The context may be determined (e.g., associated and/or defined) using one or more characteristics associated with a device state (e.g., observed or predicted).

The one or more characteristics associated with a device state may include an aspect associated with a WTRU capability. For example, the aspect associated with the WTRU capability may include one or more of the following: processing (e.g., the number of operations that can be executed in a time period, for example, per second, and/or supported by GPU, NPU, or TPU), a size of a neural network (NN) supported, quantization levels, maximum input and/or output dimensions, an inference latency, a training latency, etc. An inference latency may include the time taken by an AIML model to produce an output for a given input. The inference latency may include the time taken for pre/post-processing (e.g., any pre/post-processing) if applied. A training latency may include the time taken for an AIML model to converge. Convergence may be defined by an error metric (e.g., a difference between an actual output and a desired output) measured over a training and/or test data set below a threshold. An input dimension may be related to the size of an input, for example, in terms of the number of nodes in an AIML model at the input. An output dimension may be related to the size of an output, for example, in terms of the number of nodes in an AIML model at the output.

The one or more characteristics associated with a device state may include an aspect associated with an execution environment (e.g., one or more of a processing complexity, memory usage, a processing latency, or unexpected errors in the runtime).

The one or more characteristics associated with a device state may include a characteristic of AI model. For example, the characteristic of AI model may include one or more of the following: specific versions (e.g., different releases), a specific capability (e.g., one or more of: processing, a size of an NN supported etc.), a performance metric associated with the AI model etc. For example, one or more characteristics associated with a AI model state may include one or more of the following: a status of training, maturity of the AI model, a failure of a previous model etc.

The one or more characteristics associated with a device state may include a property of a peer WTRU component. For example, a property of a peer WTRU component may include one or more of a context of peer WTRU component or a version specific of a peer AI component or a variant thereof (e.g., associated with a gNB, CU or a logical area).

The one or more characteristics associated with a device state may include a time domain aspect (e.g., time of the day (day/night)/day of the week etc.).

The context may be determined (e.g., associated and/or defined) using the reception of signaling indicating a change of context (e.g., an indication from the network). In examples, a WTRU may receive an activation/deactivation command. For example, an activation command may include the identity of a model after a change, and a deactivation command may include an identity of a model before the change. The activation command may indicate a logical context or an identity associated with an AI model. The activation command may imply that the WTRU applies a specific AI model for the (e.g., all) subsequent transmissions or for the transmissions associated with a set of LCHs/SCells/beams etc. In examples, a DL transmission may carry an explicit or implicit identification of a context and/or an AI model. The WTRU may be configured to apply the corresponding AI model (e.g., as identified by the transmission), for example, to process at least a portion of the transmission.

The availability, configurations and/or use of an AI component/model may be determined as a function of a context. In case of a network-based control, the WTRU may receive signaling that updates the active AI model, for example, by receiving one or more of an updated AI model, a configuration (e.g., an updated configuration), a structure (e.g., an updated structure) and/or learned parameters (e.g., updated learned parameters) for the AI component and/or by receiving an indication of what configuration, structure and/or learned parameters to apply for the AI component. In case of WTRU-based selection, the WTRU may be configured to determine the applicable AI model. In examples, a WTRU may be configured with a plurality of AI models. Such AI model(s) may correspond to a given function of a protocol layer and/or to a portion of the processing chain. In examples, an (e.g., each) AI model may correspond to a respective function of a protocol layer. An (e.g., each) AI model may be trained and/or associated with a specific context.

There may be many-to-many relationship between a context and an AI model. An (e.g., each) AI model may be associated with more than one contexts. For a (e.g., each) context, more than AI model may be configured to be applicable. In some realizations, an (e.g., each) AI model may be configured with applicability criteria. The applicability criteria may indicate (e.g., implicitly identify) the context. In some examples, an (e.g., each) AI model may be configured with non-applicability criteria (e.g., contexts under which the performance of the AI model may be undefined).

An adaption of AI processing may be performed.

A WTRU may be configured with a plurality of AI models, for example, AI models with different properties/characteristics/configuration aspects. One or more of AI model properties/configuration aspects may include but not limited to type, architecture, structure, hyperparameters, connections, number and/or type of layers, number of neurons per layer, activation functions, learned parameters including weights, biases, quantization levels. Complexity of an AI model may be a function of the one or more of AI model properties/configuration aspects.

In examples, the WTRU may be configured to adapt an AI model property to yield a desirable characteristic in terms of performance and/or in terms of reducing (e.g., minimizing) one or more of the following: a power consumption, storage/memory requirement(s), an inference latency, a processing power/complexity etc. In examples, the WTRU may be configured with a base model and/or rules to derive a plurality of child models from the base model.

In some examples, more than one AI model may be used (e.g., possibly chained or grouped) to implement a wireless function. In those cases, the WTRU may be configured to perform adaption over a plurality of AI models. The adaptation may cover one or more of the AI models in the chain/group, for example, possibly using a same type of adaption or different types of adaptation.

Adaptation may be performed via a model selection.

A WTRU may be configured to adapt AI processing by selecting an AI model from a plurality of models (e.g., preconfigured models). For example, the WTRU may be configured with a plurality of AI models for a specific task. Herein the AI model may include one or more of a model type, a model structure, learned parameters of the AI model, an identity of the AI model etc. In examples, the plurality of models configured for a specific task may vary in at least one of a model type, a model structure, learned parameters, an input/output dimension and/or quantization levels. The WTRU may be preconfigured with selection criteria for an (e.g., each) AI model. For example, the WTRU may select an AI model for AI processing if the associated selection criterion may be satisfied. In an example, the selection criteria may be linked to a context. The WTRU may monitor and/or determine the current context, for example, via one or more of measurements, monitoring the configuration aspect, and/or monitoring the protocol status. The WTRU may select an AI model, for example, if the selection criteria of the AI model matches the current context. In examples, the WTRU may select the AI model whose selection criteria may be the best fit/closest to the current context. In some examples, the WTRU may be configured to report to the network if there may be no AI model that matches the current context. The WTRU may be configured to determine the performance metric of one or more (e.g., each) of the configured AI models. The performance metric may be in terms of one or more of the following: a power consumption, memory/storage, a latency, resource overhead etc.

The WTRU may be configured to select an AI model which meets the objective and/or performance requirement(s) associated with the task. The objective and/or performance requirement(s) may be a configuration aspect, for example, a configuration aspect associated with a QoS or a bearer configuration. The objective may be a function of a WTRU capability, for example, when the WTRU capability related to AI processing may be shared between multiple processes. The objective and/or performance requirement(s) may be determined based on high layer information (e.g., RRC layer, non-access stratum (NAS) layer or application QoS information). The objective may be a function of WTRU constraint(s). For example, the WTRU may trigger an AI model selection due to overheating and/or a power consumption/battery status of the WTRU.

A model structure may be adapted.

A WTRU may be configured to adapt AI processing by modifying an AI model structure (e.g., a structure of a current AI model).

In examples, the WTRU may be configured with a base model. The WTRU may be configured to derive a plurality of child model instances from the base model. The child model instances may be a subset of the base model. The WTRU may determine (e.g., derive) a child model instance by modifying the shape and/or size of the base model structure. The WTRU may determine (e.g., derive) a child model instance, for example, by adding one or more layers to the base model. For example, the WTRU may be configured with a base model and a set of preconfigured rules to derive child model instances. The WTRU may be configured to determine the learned parameters (e.g., weights) for the child model instance(s) based on the learned parameters (e.g., weights) of the base model. For example, the WTRU may apply the weights for the child model connections/layers/neurons based on corresponding weights of the connections/layers/neurons in the base model.

In examples, a (e.g., each) child model instance may be associated with a logical identity. Such logical identity may be derived from the logical identity of the base model. Such logical identity may be based on (e.g., be a function of) rules used to derive the child model. The WTRU may determine (e.g., derive) a child model instance using one or more of the following: layer-wise adaptation, neuron-wise adaptation, connectivity adaptation, or matrix rank adaptation.

The WTRU may determine (e.g., derive) a child model instance using layer-wise adaptation. An AI model may include a plurality of layers. A (e.g., each) layer may be formed by taking input from the previous layer (or input to the AI model), performing one or more transformations of the input, and produce output to the layer (e.g., the next layer) or output of the AI model. Different types of layers may be supported, for example, one or more of the flowing may be supported: FC (Fully Connected) layer, CONV (Convolutional) layer, Pooling layer, SoftMax, dropouts etc. Depending on the type of layers, different configuration of layers may be supported e.g., one or more of following may be supported: a number of channels, a number of filters, filter sizes, strides, depth etc. In an example, a WTRU may be configured to determine (e.g., derive) child models based on varying the configuration aspect of layer. in examples, a WTRU may be configured to derive a child model (e.g., a child model instance) of K layers from a base model of N layers, wherein K<N. The WTRU may remove N−K layers from the base model to from the child model. N−K layers may be consecutive. The N−K layers may be the last layers of the base model. For example, the first few layers of the AI model may be important for good representations, and/or the adaptation may be performed on the last few layers. The location of N−K layers may be configured (e.g., explicitly) to the WTRU. For example, the WTRU may receive configuration information that indicates the location of N−K layers. The WTRU may add a layer (e.g., a SoftMax layer) to the (K+1)^{th} layer of the child model. The WTRU may configure the dimension of the SoftMax layer, for example, as a function of the K^{th} layer dimension in the child model.

The WTRU may determine (e.g., derive) a child model instance using neuron-wise adaptation. A (e.g., each) layer in the AI model may include a plurality of neurons. A (e.g., each) neuron may perform a sum (e.g., a weighted sum) of the inputs (e.g., for example, including a bias value) and/or produce an output based on an activation function (e.g., a non-linear activation function like Rectified Linear Units (ReLU), Sigmoid or the likes). In an example, the WTRU may be configured to determine a child model (e.g., a child model instance) by adapting the number of neurons per layer in the base model. For example, the WTRU may be configured to remove J neurons from L^{th} layer. The value of J may be different for different layers. In examples, the allowed values of J, L etc. may be preconfigured for the WTRU. The WTRU may reconfigure/dimension some layers in the child model, for example, to account for the adaptation.

The WTRU may determine (e.g., derive) a child model instance using connectivity adaptation. A WTRU may be configured to derive a child model (e.g., a child model instance) from the base model by adapting the connectivity between layers within the base model. For example, the WTRU may be configured to skip connections in the base model to derive a child model. In examples, the WTRU may be configured with a sparsity configuration, which may indicate the number of connections to drop. The WTRU may drop some connections, for example, connections whose weight may be below a preconfigured threshold.

The WTRU may determine (e.g., derive) a child model instance using matrix rank adaptation. A WTRU may be configured to determine (e.g., derive) a child model (e.g., a child model instance) by applying rank adaption of weight matrices associated with base model. For example, the rank adaptation may correspond to low rank approximation techniques. In examples, the WTRU may be use different techniques (e.g., Singular Value Decomposition (SVD), Principal Component Analysis (PCA) etc.) to perform rank adaptation. An amount of rank reduction may be preconfigured for the WTRU. The matrix rank adaption may result in a reduction of the number of operations and/or memory/storage and/or power consumption associated with AI processing.

Based on one or more triggers for AI processing adaption described herein, the WTRU may be configured to perform model structure adaption by switching from a base model to a child model (e.g., a child model instance) or switching from a child model to a different child model (e.g., a different child model instance) or switching from a child model to the base model. Switching here may include using a different AI model than the current AI model used for AI processing. One or more examples or techniques herein may be extended to multiple base models and child models derived thereof.

Model input/output dimension may be adapted.

A WTRU may be configured to adapt AI processing by modifying the dimensions of input and/or output to the AI model. In examples, the WTRU may be configured with specific input and/or output dimensions for the base model. The WTRU may be configured to determine (e.g., derive) a plurality of child model instances from the base model. The child model(s) (e.g., the child model instances) may have input and/or output dimension(s) different than that of the base model. The WTRU may apply a model structure adaptation or model quantization adaptation, for example, in combination with a model input/output dimension adaptation, to derive the child model(s).

The WTRU may modify the input and/or output dimension to the model (e.g., the AI model that is used for AI processing) based on one or more of preconfigured rules. The input dimension may be resource grid in time/frequency and/or space. The WTRU may adapt the input dimension, for example, by performing preprocessing of the input. The WTRU may apply dimensionality reduction techniques (e.g., techniques such as principal component analysis (PCA), singular value decomposition (SVD) etc.). The WTRU may be configured with a first AI model to perform preprocessing of input to a second AI model. For example, the first AI model may perform ML (e.g., unsupervised learning). The WTRU may apply sub sampling to adjust the input dimension. For example, the output dimension may correspond to the number of classes. A (e.g., each) class may represent a range of values. In examples, the output dimension may correspond to a latent vector. An adaptation (e.g., a reduction) of output dimension may lead to a reduced size of the latent vector.

The WTRU may be configured with allowed values for input and/or output dimensions. The WTRU may be configured with allowed values for output dimension for a given input dimension or vice versa. In examples, a (e.g., each) child model instance may be associated with a logical identity. Such logical identity may be determined (e.g., derived) from the logical identity of the base model. Such logical identity may be a function of rules used to derive the child mode (e.g., the child model instance).

Model quantization may be adapted.

A WTRU may be configured to adapt AI processing by modifying the model weights (e.g., model weights of the AI model that is used for AI processing), for example, while retaining the model structure/computational graph associated with the AI model. In examples, the WTRU may be configured with a base model having model weights, activations, and model structure/computational graph. The WTRU may be configured to determine (e.g., derive) a plurality of child model instances from the base model. The WTRU may apply the base model structure for a child model (e.g., the child model instance(s)). The WTRU may determine the learned parameters (e.g., weights) of the child model instance, for example, as a function of learned parameters (e.g., weights) in the base model. For example, the WTRU may be configured with a base model and a set of preconfigured rules to determine (e.g., derive) the weights of the child model instances. In examples, the WTRU may determine (e.g., derive) child model weights by quantizing the base model. For example, the quantization process may result in a change in the bit width/resolution of model weights and/or activations. The WTRU may apply different levels of quantization to obtain different child model instances. The WTRU may apply different types of quantization. For example, the WTRU may apply uniform quantization, logarithmic quantization, or the likes. The WTRU may combine different quantitation types along with different quantization levels to obtain the plurality of child models. The WTRU may be configured with allowed levels and/or types of quantization. In one or more examples herein, the WTRU may apply quantization for activation values. In examples, a (e.g., each) child model instance may be associated with a logical identity. Such logical identity may be determined (e.g., derived) from the logical identity of the base model. Such logical identity may be a function of rules used to determine (e.g., derive) the child model.

Quantization may reduce the number bits used (e.g., required) to represent the model weights and/or activation values. For example, quantized AI model weights and/or activation values may use (e.g., require) reduced memory for AI processing and/or reduced power consumption for AI processing and/or reduced computational load for AI processing. Quantization of model weights may reduce the complexity of AI processing (e.g., in some cases, at the cost of reduced AI model inference/performance). In examples, the WTRU may be configured with mapping between AI model accuracy and different quantization levels/types. Such mapping may be part of AI model configuration. Such mapping may be configured as a table. The WTRU may be configured to choose a specific quantization based on target objective, for example, while maintaining the model accuracy above a threshold.

Triggers (e.g., one or more triggering conditions) may be used for a change of a data processing model (e.g., AI processing adaptation).

Triggers may be based on a dynamic context (e.g., as shown in the example 300 of FIG. 3).

A WTRU may adapt AI processing using adaptation triggered based on change in context, for example, to improve an AI model performance (e.g., inference accuracy). FIG. 3 illustrates exemplary features associated with changing an AI model based on a context change.

A difference (e.g., a key difference) between rule-based processing and the AI processing may include that the performance of AI processing may not be constant. The performance associated with AI processing may be adjusted with varying levels of granularity. This may be different from rule-based processing, which, for example, may be tested for minimal performance requirement(s), and the WTRU performance would be substantially constant over time. For example, the performance of AI processing may be a function of different aspects including one or more of the context of operation, maturity of training, WTRU capability etc. The context of operation may change dynamically, for example, due to a change in one or more of channel conditions, available resources, radio resource configuration, location, QoS, WTRU protocol state, change in traffic mix/requirements, etc.

A WTRU may be configured to adapt AI processing, for example, to improve the performance of an AI model. For example, the WTRU may be preconfigured with one or more performance thresholds, and an (e.g., each) AI model may be associated with a performance threshold. The WTRU may choose an AI model for processing based on the performance threshold. In examples, the WTRU may be configured to monitor the performance of an AI model, for example, by monitoring a metric associated with a wireless function. For example, the WTRU may apply an AI model for CSI feedback compression. The WTRU may be configured to monitor for the number of hybrid automatic repeat request (HARQ) NACKs generated over a preconfigured time period. If the number of HARQ NACKs goes above a threshold, the WTRU may be configured to trigger an AI model adaptation. For example, the AI model adaptation may result in applying a different AI model whose associated performance metric may be higher than the current AI model. In some examples, the WTRU may be configured to adapt an AI model so that the performance of AI processing may be constant over a time period. For example, the WTRU may adapt its AI model to compensate for a change in the context, for example, such that the impact to the performance is kept minimal.

In examples, the AI models may be contextualized, and a (e.g., each) AI model may be associated with a preconfigured expected performance metric. In some examples, the WTRU may be configured implicitly or explicitly the information about the training data distribution (or data drift) that is applied to train an AI model. The WTRU may monitor the input data to the AI model. The WTRU may determine if the input may be significantly different from the training data distribution. The WTRU may trigger an AI model adaptation, for example, if the WTRU determines that the input data distribution drifts from an expected data distribution. An example of the expected data distribution may include the training data distribution.

In examples, a WTRU may be configured to report to the network the performance of an AI model. Such reports may be used for the network to adjust the operating point to be more or less aggressive. Such reports may be used for the network to determine if a model retraining may be used or needed. Such reports may be used for the network to determine one or more configuration aspects (e.g., adjusting one or more of the following: the presence, periodicity and/or density of reference signals etc.)

An example for the adaptation of an AI model based on a context (e.g., as a function of a context) may include one or more of the following.

In the example for the adaptation of an AI model based on a context, a WTRU may be configured with a first AI model and a second AI model (e.g., as shown in 302 of FIG. 3). The first AI model and the second AI model may differ in one or more of the following: a model structure, a model type, a layer configuration, a model input/output dimension, learned parameters of the model including model weights, model quantization etc.

In the example for the adaptation of an AI model based on a context (e.g., as shown in 304 of FIG. 3), the first AI model and the second AI model may be preconfigured to be associated with a first context and a second context, respectively. The first context may be a WTRU measurement value (Reference Signals Received Power (RSRP), Reference Signal Received Quality (RSRQ), Signal-to-Interference-plus-Noise Ratio (SINR) etc.) within a first range, and a second context may be a WTRU measurement value within a second range. The first context may be associated with a first BWP or frequency range and a second context may be associated with a second BWP or frequency range. The first context may be associated with a first logical area/location, and a second context may be associated with a second logical area/location. The first context may be associated with a first MIMO configuration, and a second context may be associated with a second MIMO configuration. The first context may be associated with a first reference signal configuration, and a second context may be associated with a second reference signal configuration. The first context and second context may be associated with one or a combination of contexts (e.g., as defined herein). The WTRU may receive information about performance metric of the first AI model under the first context and information about performance metric of second AI model under the second context. The WTRU may be configured with the rules for a selection of AI model based on the context. The rules may be a function of the context.

In the example for the adaptation of an AI model based on a context, the WTRU may apply the first AI model for a wireless function (e.g., CSI feedback determination and/or compression), for example, as shown in 306 of FIG. 3. The WTRU may monitor for a context change, as shown in 308 of FIG. 3.

Based on (e.g., upon) a preconfigured trigger condition associated with a change in the context (e.g., as shown in 310 of FIG. 3), the WTRU may (e.g., autonomously) activate the second AI model and apply the second AI model for the wireless function, for example, when one or more of the following occurs: when the WTRU measurement (RSRP, RSRQ, SINR etc.) changes from a first range to a second range (e.g., data processing models may be trained at different RSRP, RSRQ, SINR ranges; a data processing model trained at a narrower range may perform better at the narrow range); when the active BWP or frequency range of the serving carrier changes from a first context to a second context (e.g., CSI-RS may cover the full bandwidth of the first BWP, and CSI-RS may cover a fraction of the second BWP; the first BWP may be associated with a first numerology such as a first subcarrier spacing, and the second BWP may be associated with a second numerology such as a second subcarrier spacing; a first bandwidth of the first BWP may be different from a second bandwidth of the second BWP); when the WTRU location changes from a first logical area/location to a second logical area/location (e.g., cell-specific and/or deployment specific parameters may change when location changes); when the MIMO configuration changes from a first context to a second context (e.g., an input/output dimension of a data processing model may be adapted when the MIMO configuration range changes); when the reference signal configuration changes from first context to a second context. As shown in 310 of FIG. 3, if a change in context occurs, the WTRU may adapt the first AI model or switch to a second AI model at 312 of FIG. 3. As shown in 310 of FIG. 3, if a change in context does not occur, the WTRU may not adapt the first AI model or switch to a second AI model. The WTRU may continue to monitor for a context change, as shown in 308 of FIG. 3.

In the example for the adaptation of an AI model based on a context (e.g., as shown in 314 of FIG. 3), the WTRU may indicate the activation of the second AI model, for example, to the network explicitly or implicitly. For example, the WTRU may apply any indication procedures described herein. The WTRU may transmit an indication including one or more of an adaptation of the AI model, a reason or context for the adaptation, or an extent of the adaptation. The adaptation may include a conditional reconfiguration of the first AI model.

The example for the adaptation of an AI model based on a context herein may be extended to more than two AI models.

Triggers may be based on a variable WTRU capability (e.g., as shown in the example 200 of FIG. 2A).

A WTRU may adapt AI processing using an adaptation triggered based on change(s) in WTRU capabilities, for example, to tradeoff an AI model performance to handle variable WTRU capability. An example of an adaptation triggered based on change(s) in WTRU capabilities is shown in FIG. 2A.

A WTRU may have a finite number of computational resources for performing AI processing. In some examples, the WTRU may have specialized processing hardware for AI processing. For example, the WTRU may have one or more of GPUs (Graphical Processing Units), NPUs (Neural Processing Units), TPUs (Tensor Processing Units) etc. A WTRU's capability (e.g., the WTRU's capability associated with AI processing) may change, for example, dynamically. As shown in 208 of FIG. 2A, the WTRU capability may change dynamically, for example, due to the sharing of available processing power, storage etc. among a plurality of processes/functions. As shown in 208 of FIG. 2A, the WTRU may be configured to monitor a change in WTRU capability. For example, at a time instant (e.g., at any time instant), the available processing power (e.g., AI processing power) at the WTRU may be shared between functions associated with air interface (e.g., PHY layer, L2/3 etc.). In examples, the WTRU may allocate processing power (e.g., AI processing power) to a first wireless function by preempting the processing resources allocated to a second wireless function. Wireless functions may include one or more of the following: channel estimation, demodulation, RS measurements, HARQ, CSI feedback (e.g., CSI feedback determination and/or compression), positioning, beam management, DL transmissions, UL transmissions, etc. For example, at a time instant (e.g., any time instant), the available processing power at the WTRU may be shared between function(s) associated with air interface and the function(s) outside the air interface including application-level function(s) (e.g., one or more of the following: image processing, video processing, natural language processing etc.). In some examples, the WTRU may allocate processing power (e.g., AI processing power) to non-wireless function(s), for example, by preempting the processing resources allocated to wireless function, or vice versa. In examples, the processing power (e.g., AI processing power) may be shared between training on a first AI model and performing inference on a second AI model.

The available processing power (e.g., AI processing power) at the WTRU may not be constant. The WTRU may handle the variability in the processing power, for example, based on one or more rules (e.g., pre-determined rules). The WTRU may be configured with the one or more rules to handle the variability in the processing power. For example, the one or more rules may include one or more triggering conditions. As shown in 210 of FIG. 2A, if a change in WTRU capability is detected, the WTRU may be configured to determine an adaptation to the first AI model. As shown in 210 of FIG. 2A, if the WTRU does not detect a change in WTRU capability, the WTRU may not adapt the first AI model and continue to monitor for the WTRU capability change. The WTRU may be configured to change a data processing model (e.g., adapt the AI model) according to a change in the WTRU's processing capability (e.g., to fit the available processing power). As shown in 212 of FIG. 2A, the WTRU may be configured to determine an adaptation to the first AI model. In examples, a WTRU, based on (e.g., upon) a reduction in available processing power, may adapt the AI model such that the AI processing associated with the AI model may be reduced, for example, as shown in 212 of FIG. 2A. If the reduction in the available processing power is equal to or greater than a certain value (e.g., a threshold), the WTRU may further adapt the AI model or switch to a different AI model. One or more of the following may occur according to the reduction in the available processing power: for example, the WTRU may switch to an AI model which has lower complexity; the WTRU may reduce the number of layers in the AI model; the WTRU may reduce the quantization level; the WTRU may reduce the input and/or output dimension. For example, the WTRU may use a first AI model. The WTRU may be configured to use a second AI model if the reduction in the available processing power is less than a certain value. Comparing to the first AI model, the second AI model may have a less number of layers. The WTRU may be configured to use a third AI model if the reduction in the available processing power is equal to or greater than the certain value. Comparing to the first AI model, the third AI model may have a less number of layers and a lower quantization level. In some examples, the AI model with lower complexity may result in reduced performance. The WTRU may be configured with a maximum allowed performance degradation, for example, while performing such adaptation. For example, the WTRU may be configured to adapt a model (e.g., a data processing model) as long as the expected performance may be within a preconfigured range.

An example for the adaptation of computations/complexity associated with AI processing may include one or more of the following:

In the example for the adaptation of computations/complexity associated with AI processing, a WTRU may be configured with a first AI model and a second AI model. For example, the WTRU may receive configuration information indicating the first AI model (e.g., as shown in 204 of FIG. 2A) and/or the second AI model. The first AI model may be different from the second AI model. For example, the first AI model may be different from the second AI model in terms of processing complexity. The second AI model may be of lower processing complexity than the first AI model. The second AI model may be configured such that the number of operations to perform inference may be less than the first AI model. The first AI model and the second AI model may be characterized by different data processing parameters. The first AI model and the second AI model may differ in one or more of the following: a model structure, a model type, a layer configuration, a mode input/output dimension, learned parameters of the model including model weights, model quantization etc. The processing complexity may include but not limited to one or more of the following: memory to store the AI model, the number of operations (e.g., one or more of the following operations: possibly tensor operations, matrix multiplication, addition, thresholding, max/min operation etc.) that may be executed in a time period (e.g., per second), the number of memory access per time period, etc. In some examples, the inference accuracy associated with second AI model may be lower than the first AI model.

In the example for the adaptation of computations/complexity associated with AI processing, the WTRU may apply the first AI model for a wireless function (e.g., CSI feedback determination and/or compression), for example, as shown in 206 of FIG. 2A. For example, the WTRU may be configured to determine first CSI feedback information using the first AI model and transmit an indication of the determined first CSI feedback information. Based on a trigger condition (e.g., upon a preconfigured trigger condition), for example, when the available processing power at the WTRU becomes lower than required for processing using the first AI model (e.g., a change of the WTRU's processing power is equal to or greater than a first threshold), the WTRU may (e.g., autonomously) activate the second AI model and/or apply the second AI model for the wireless function. The second AI model may include an adaption of the first AI model. As shown in 214 of the example of FIG. 2A, the WTRU may be configured to apply the adaptation to the first AI model. The WTRU may be configured to determine second CSI feedback information using the second AI model and transmit an indication of the determined second CSI feedback information. The adaptations to the first AI model may be applied via layer-wise, neuron-wise, connectivity-wise, quantized and/or low rank adaptations.

FIG. 2B illustrates an example for adapting an AI model (e.g., based on a capability change). Comparing 220 of FIG. 2B and 218 of FIG. 2B, the adaption to the first AI model includes a reduction of the number of nodes and the type/number of connectivities.

In the example for the adaptation of computations/complexity associated with AI processing, the WTRU may indicate the activation of the second AI model to the network either explicitly or implicitly, for example, as shown in 216 of FIG. 2A, the WTRU may be configured to send an indication of the second AI model or the third AI model, for example, to a base station.

In the example for the adaptation of computations/complexity associated with AI processing, the WTRU may be configured to switch back to the first AI model or switch to a third AI model, for example, when the additional processing resources become available. The WTRU may indicate the activation of the first AI model to the network.

The example for the adaptation of computations/complexity associated with AI processing may be extended to more than two AI models. In some examples, based on the trigger condition, for example, when the available processing power at the WTRU becomes lower than required for processing using the first AI model (e.g., a change of the WTRU's processing power is equal to or greater than a first threshold and less than a second threshold), the WTRU may (e.g., autonomously) activate the second AI model and/or apply the second AI model for the wireless function. The WTRU may (e.g., autonomously) activate a third AI model and/or apply the third AI model for the wireless function when the available processing power at the WTRU becomes lower than required for processing using the second AI model (e.g., a change of the WTRU's processing power is equal to or greater than the second threshold). In some examples, the WTRU may switch to the third AI model when the available processing power at the WTRU becomes lower than required for processing using the second AI model, and the third AI model may not have a data processing parameter in common with the first AI model.

In some examples, based on (e.g., upon) a trigger condition associated with WTRU capability change, the WTRU may be configured to apply available processing power (e.g., AI processing power) based on a priority associated with a wireless function (e.g., to the highest priority wireless function). For example, the WTRU may be configured with priorities for various wireless functions. The prioritization of available processing power may be modeled similar to a logical channel prioritization procedure, wherein different wireless functions (for example, instead of logical channels) may be considered for prioritization. A (e.g., each) wireless function may be configured with suitable or guaranteed processing power (e.g., AI processing power including memory, cycles, etc.).

In some examples, a decrease in AI processing capability may be temporary. The WTRU may be configured to delay the AI processing associated with a wireless function, for example, when a trigger condition associated with a lack of WTRU capability occurs. The WTRU may be configured to skip the AI processing, for example, when a trigger condition associated with a lack of WTRU capability occurs.

Triggers may be based on a model performance tradeoff.

A WTRU may adapt AI processing to tradeoff AI model performance to achieve an objective w.r.t, for example, one or more of the following: power consumption, memory, latency, overhead or processing complexity.

In examples, a WTRU may be configured to adapt AI processing such that the AI model performance may be traded-off to achieve one or more desired objective. For example, the AI model may learn from experience (e.g., observing data and/or environment) over a period of time. The performance of an AI model may evolve over a time period. A WTRU may adapt AI processing wherein the adaption may lead to a reduction in one or more of the following: a power consumption, memory usage, a latency, overhead or processing requirement(s), for example, at the cost of a reduction in AI model inference performance and/or an increase in signaling overhead. For example, when AI processing may be applied to wireless functions (e.g., one or more of the following: channel estimation, demodulation, RS measurements, HARQ, CSI feedback, positioning, beam management etc.), it may be possible to perform granular adjustment to tradeoff a model performance to achieve an objective. For example, the WTRU may adapt the processing to accomplish one or more of the following: a reduction in power consumption, a reduction memory/storage utilization, a reduction in Latency, or a reduction in processing power (e.g., computational resources).

An example for the adaptation of a power consumption associated with AI processing may include one or more of the following.

In the example for the adaptation of a power consumption associated with AI processing, a WTRU may be configured with a first AI model and a second AI model. The first AI model and the second AI model may differ in one or more of the following: a model structure, a model type, a layer configuration, a mode input/output dimension, learned parameters of the AI model including model weights, model quantization etc. The first AI model and the second AI model may be associated with a selection criterion. For example, the rules for the selection of an AI model may be associated with a power saving state of the WTRU.

In the example for the adaptation of a power consumption associated with AI processing, the first AI model and the second AI model may be configured with different characteristics, such that the inference accuracy associated with the second AI model may be lower than that associated with the first AI model, and/or, the power consumption associated with second AI model may be lower than that associate with the first AI model. For example, the second AI model may be configured such that the number of operations to perform inference may be less than the first AI model.

In the example for the adaptation of a power consumption associated with AI processing, the WTRU may apply the first AI model for a wireless function (e.g., a CSI feedback determination and/or compression), based on (e.g., upon) a preconfigured trigger condition, for example, when the WTRU transitions to a lower power saving state, and/or when the WTRU transitions from a first power saving state to a second power saving state.

In the example for the adaptation of a power consumption associated with AI processing, the WTRU may (e.g., autonomously) activate the second AI model and apply the second AI model for the wireless function.

In the example for the adaptation of a power consumption associated with AI processing, the WTRU may indicate the activation of the second AI model (e.g., to the network) explicitly or implicitly.

The example for the adaptation of a power consumption associated with AI processing may be extended to more than two AI models.

An example for the adaptation of the latency associated with AI processing may include one or more of the following.

In the example for the adaptation of the latency associated with AI processing, a WTRU be configured with a first AI model and a second AI model. The first AI model and the second AI model may differ in one or more of the following: a model structure, a model type, a layer configuration, a mode input/output dimension, learned parameters of the AI model including model weights, model quantization etc. The first AI model and the second AI model may be associated with a selection criterion. For example, the rules for a selection of an AI model may be associated with the latency of inference using that AI model.

In the example for the adaptation of the latency associated with AI processing, the first AI model and second AI model may be configured with different characteristics, such that the inference accuracy associated with the second AI model may be lower than that associated with the first AI model or the inference latency associated with the second AI model may be lower than that associated with the first AI model.

For example, the second AI model may be configured such that the number of operations to perform inference may be less than the first AI model.

In the example for the adaptation of the latency associated with AI processing, the WTRU may apply the first AI model for a wireless function (e.g., CSI feedback determination and/or compression), based on (e.g., upon) a preconfigured trigger condition, for example, when the UL transmission occasion may be earlier than the inference latency of the first AI model, and/or when the inference latency of the first AI model exceeds the QoS requirements of data associated with the UL transmission.

In the example for the adaptation of the latency associated with AI processing, the WTRU may (e.g., autonomously) activate the second AI model and apply the second AI model for the wireless function.

In the example for the adaptation of the latency associated with AI processing, the WTRU may indicate the activation of the second AI model (e.g., to the network) explicitly or implicitly.

The example for the adaptation of the latency associated with AI processing may be extended to more than two AI models.

WTRU monitoring and signaling aspects may be provided in relation to the adaptive AI processing herein.

A WTRU may be configured to monitor for a change in a context associated with one or more AI models, for example, as shown in 308 of FIG. 3.

In examples, a WTRU may be configured to monitor for a change in a context associated with one or more AI models. The WTRU may determine the context(s) to monitor, for example, based on configured and/or activated AI models. The WTRU may select an AI model among a plurality of configured AI models for a specific wireless function, for example, based on the context associated with the AI model that matches the current context. A WTRU may be configured to apply/activate the selected AI model, for example, based on network command(s). A WTRU may be configured to apply/activate an AI model that may be configured as a default one, for example, until a context may be determined. A WTRU may be configured to monitor for a change in a context. The WTRU may determine the context(s) to monitor, for example, based on the currently active AI model(s). The WTRU may determine the context(s) to monitor, for example, based on the currently configured AI model(s). For example, during a change of a context, the WTRU may be configured to use a specific AI model which may be chosen based on or more of the following: determined implicitly based on a different context (e.g., a new context), signaled explicitly by the network, or a default/preconfigured behavior (e.g., there may be a reset to the initial state unless the signaling indicates “continue”).

Based on (e.g., upon) a detection of a change in a WTRU context and/or a change in WTRU capability related to AI processing, the WTRU may be configured to perform one or more of the following: the WTRU may adapt the AI processing (e.g., using various techniques as described herein); the WTRU may indicate to the network that an adaptation has occurred (e.g., so that the network may choose its peer AI model); the WTRU may indicate (e.g., to the network) a change in WTRU capability; the WTRU may indicate (e.g., to the network) a change in a context related to AI processing at the WTRU; the WTRU may indicate (e.g., to the network) that a different AI model (e.g., a new AI model/an AI model download/an AI model update) may be used or needed for AI processing; the WTRU may indicate (e.g., to the network) that a retraining of the AI model may be used or needed; the WTRU may fall back to legacy rule-based processing; the WTRU may fall back to a default model; the WTRU may fall back to a default behavior. The default model may be trained under a wide range of contexts. The default model may provide an acceptable performance. The default behavior may be a simplified rule-based processing.

Modeling of signaling aspects may be provided in relation to the adaptive AI processing herein.

In examples, a WTRU may be provided with an AI model configuration and/or the rules to derive/adapt the AI models, for example, via RRC (re)configuration. For example, the WTRU may apply one or more AI model updates, based on (e.g., upon) receiving a RRC (re)configuration containing the AI model configuration. The WTRU may be configured with different event configurations to monitor and/or report the AI/ML model performance. The WTRU may be configured with different event configurations to monitor and/or report change(s) in the context. The WTRU may receive an AI model update in a conditional RRC reconfiguration. The reconfiguration may include a configuration of an AI model. The condition may include a performance threshold associated with (e.g., linked to) the AI model. The condition may include a configuration of a context associated with (e.g., linked to) the AI model. The WTRU may (e.g., autonomously) apply the AI model configuration, for example, when the associated condition may be satisfied. The WTRU may be configured with one or more default rules to apply an AI model configuration. The default rules may include error event(s). In one or more examples, the WTRU may be configured with a plurality of AI models via an RRC configuration. A subset of preconfigured AI models and/or contexts may be semi-statically activated/deactivated, for example, via an MAC control element. The WTRU may be dynamically configured to apply an AI model, for example, by L1/PHY control signaling (e.g., DCI). One or more of the following in the DCI: the search space, the CORESET, the DCI format, the RNTI, or bits may implicitly or explicitly indicate an AI model to be applied.

A WTRU may send an indication of AI processing adaptation.

A WTRU may be configured to transmit an indication of the AI model used for processing a DL transmission or a portion thereof. The WTRU may be configured to transmit such indication when (e.g., only when) there may be a change in the AI model for the aforementioned processing. In some examples, a WTRU may be configured to transmit an indication of the AI model that the WTRU has determined to use for processing a future DL transmission or portion thereof. The indication may be implicit or explicit. In examples, the indication may be included in a UL transmission on resources preconfigured for such indication (e.g., on PUCCH, preambles or similar) or acquired by the WTRU (e.g., UL grant received by the WTRU for such indication). In some examples, the indication may be multiplexed along with other data and/or control information in a UL transmission. In some examples, the WTRU may be configured to transmit the indication periodically, semi-persistently or based on request (i.e., aperiodically).

A WTRU may be configured to transmit an indication of the AI model used for processing an UL transmission or a portion thereof. The WTRU may be configured to transmit such indication when (e.g., only when there may be a change in the AI model for the aforementioned processing). The indication may be implicit or explicit. In examples, the indication may be included in the corresponding UL transmission. In some examples, the indication may be transmitted at a preconfigured offset, for example, in terms of time and/or frequency in relation to the corresponding UL transmission. In some examples, the WTRU may be configured to transmit the indication periodically, semi-persistently or based on request (i.e., aperiodically). The indication may include one or more of the following: a logical identity of the AI model, reason(s) for adaptation, information about the context etc. For example, the identity of the AI model and/or information about the context may be determined (e.g., derived) from an AI model configuration. For example, a reserved value of the AI model may indicate that an absence of an appropriate AI model at the WTRU. The reserved value may indicate the need for an AI model download. The reserved value may indicate a need for AI model retraining.

The WTRU may be configured to transmit the indication in one or more of the following ways: in a MAC Control Element (CE); in a layer 1 transmission (e.g., a PUCCH resource or RA preamble or 2-step RACH resource); in an RRC message (e.g., the indication may be modeled as a synchronization of a configuration between the WTRU and the network).

The WTRU may be configured to receive a response to the indication in one or more of the following: a Medium Access Control control element (MAC CE), a random access response (RAR), or a DCI message. The WTRU may consider a response as an acknowledgement of the WTRU determination, for example, if the transmitted indication is associated with future DL transmission(s). The WTRU may apply the indicated AI model if (e.g., only if) a successful response may be received.

A WTRU may be configured to receive an explicit or implicit indication related to AI processing, for example, in a DL or a UL transmission. The indication may be carried in one or more of the following: a DCI, MAC CE or a RRC message. The indication may configure the WTRU to perform one or more of the following. The WTRU may determine an AI model based on the indication and/or use that AI model to process the specific DL transmission or UL transmission or a portion thereof. The specific DL transmission or UL transmission may be associated with a DL assignment that carries the indication or an UL grant that carries the indication. For example, the DL assignment that carries the indication or the UL grant that carries the indication may be received in a DCI. The WTRU may determine an AI model based on the indication and/or use that AI model to process some or all the subsequent DL or UL transmissions or a portion thereof, for example, for a preconfigured time period or until an error may be encountered. The WTRU may determine an AI model based on the indication and use that AI model to process a selected subset of subsequent DL or UL transmissions. For example, the subset may be determined based on the indication or a property of the DL or UL transmission(s).

In one or more examples, the WTRU may be configured to determine if the model indicated for AI processing may be in accordance with the WTRU capability. In some examples, the WTRU capability associated with AI processing may not be constant. If the WTRU cannot apply the indicated AI model, the WTRU may transmit a control message informing that the indicated model cannot be used for AI processing. The WTRU may include the reason(s) for the inability to comply e.g., AI model exceeding WTRU capability. The WTRU may indicate the current WTRU capability that it can allocate to AI processing.

In one or more examples herein, the WTRU may be configured to indicate a change in a context, and, the WTRU may adapt the AI model, for example, based on a confirmation from the network. In one or more examples herein, the WTRU may be configured to indicate a change in WTRU capability, and, the WTRU may adapt the AI model, for example, based on confirmation from the network. Such a WTRU behavior may be defined, for example, if no AI model may be configured for the context and/or WTRU capability.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the examples described herein consider LTE, LTE-A, New Radio (NR) or 5G specific protocols, it is understood that the examples described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
determine, based on received configuration information, a first data processing model of channel state information (CSI) feedback determination;
determine that a first triggering condition has been satisfied, wherein the first triggering condition comprises a condition that a change in a processing capability associated with the WTRU is greater than a value;
determine a second data processing model of CSI feedback determination based on the satisfaction of the first triggering condition; and
send a transmission that indicates the second data processing model of CSI feedback determination and the satisfaction of the first triggering condition.

17. The WTRU of claim 16, wherein the transmission indicates a reason for a usage of the second data processing model of CSI feedback determination, and wherein the reason for the usage of the second data processing model comprises the satisfaction of the first triggering condition.

18. The WTRU of claim 16, wherein the value is a first value, wherein the first triggering condition is that the change in the processing capability associated with the WTRU is greater than the first value and less than a second value, and wherein the processor is further configured to:
determine that a second triggering condition has been satisfied, wherein the second triggering condition comprises a condition that the change in the processing capability associated with the WTRU is greater than the second value;
determine a third data processing model of CSI feedback determination based on the satisfaction of the second triggering condition; and
send a transmission that indicates the third data processing model of CSI feedback determination and the satisfaction of the second triggering condition.

19. The WTRU of claim 16, wherein the change of the processing capability associated with the WTRU comprises a change in a processing power allocated to the first data processing model of CSI feedback determination.

20. The WTRU of claim 16, wherein the second data processing model of CSI feedback determination is determined based on an adaptation of the first data processing model of CSI feedback determination, and wherein the transmission further indicates at least one of: a type of the adaptation of the first data processing model; or an extent of the adaptation of the first data processing model.

21. The WTRU of claim 16, wherein the processor is further configured to:
generate a number of hybrid automatic repeat request (HARQ) negative acknowledgements (NACKs) over a preconfigured amount of time; and
determine a performance metric associated with the first data processing model based on the number of HARQ NACKs generated over the preconfigured amount of time, wherein the second data processing model is determined further based on the performance metric associated with the first data processing model.

22. The WTRU of claim 16, wherein the processor is further configured to:
perform channel measurements, wherein the channel measurements comprise a first reference signal received power (RSRP) associated with a channel and a second RSRP associated with the channel, and wherein the first RSRP is associated with a first measurement range, and the second RSRP is associated with a second measurement range;
determine that a second triggering condition has been satisfied, wherein the second triggering condition comprises a condition that the first measurement range associated with the first RSRP and the second measurement range associated with the second RSRP are different;
determine a third data processing model of CSI feedback determination based on the satisfaction of the second triggering condition; and
send a transmission that indicates the third data processing model of CSI feedback determination and the satisfaction of the second triggering condition.

23. The WTRU of claim 16, wherein the processor is further configured to:
determine that a second triggering condition has been satisfied, wherein the second triggering condition comprises a condition that the WTRU changes from using a first bandwidth part (BWP) to using a second BWP, and wherein a frequency range of the first BWP and a frequency range of the second BWP are different;
determine a third data processing model of CSI feedback determination based on the satisfaction of the second triggering condition; and
send a transmission that indicates the third data processing model of CSI feedback determination and the satisfaction of the second triggering condition.

24. The WTRU of claim 16, wherein the received configuration information indicates a configuration of the first data processing model of CSI feedback determination, a configuration of the second data processing model of CSI feedback determination, and the first triggering condition.

25. The WTRU of claim 16, wherein the processor is further configured to receive a radio resource control message that indicates the first triggering condition.

26. A method performed by a wireless transmit/receive unit (WTRU), comprising:
determining, based on received configuration information, a first data processing model of channel state information (CSI) feedback determination;
determining that a first triggering condition has been satisfied, wherein the first triggering condition comprises a condition that a change in a processing capability associated with the WTRU is greater than a value;
determining a second data processing model of CSI feedback determination based on the satisfaction of the first triggering condition; and
sending a transmission that indicates the second data processing model of CSI feedback determination and the satisfaction of the first triggering condition.

27. The method of claim 26, wherein the transmission indicates a reason for a usage of the second data processing model of CSI feedback determination, and wherein the reason for the usage of the second data processing model comprises the satisfaction of the first triggering condition.

28. The method of claim 26, wherein the value is a first value, wherein the first triggering condition is that the change in the processing capability associated with the WTRU is greater than the first value and less than a second value, and wherein the method further comprises:
determining that a second triggering condition has been satisfied, wherein the second triggering condition comprises a condition that the change in the processing capability associated with the WTRU is greater than the second value;
determining a third data processing model of CSI feedback determination based on the satisfaction of the second triggering condition; and
sending a transmission that indicates the third data processing model of CSI feedback determination and the satisfaction of the second triggering condition.

29. The method of claim 26, wherein the change of the processing capability associated with the WTRU comprises a change in a processing power allocated to the first data processing model of CSI feedback determination.

30. The method of claim 26, wherein the second data processing model of CSI feedback determination is determined based on an adaptation of the first data processing model of CSI feedback determination, and wherein the transmission further indicates at least one of: a type of the adaptation of the first data processing model; or an extent of the adaptation of the first data processing model.

31. The method of claim 26, further comprising:
generating a number of hybrid automatic repeat request (HARQ) negative acknowledgements (NACKs) over a preconfigured amount of time; and
determining a performance metric associated with the first data processing model based on the number of HARQ NACKs generated over the preconfigured amount of time, wherein the second data processing model is determined further based on the performance metric associated with the first data processing model.

32. The method of claim 26, further comprising:
performing channel measurements, wherein the channel measurements comprise a first reference signal received power (RSRP) associated with a channel and a second RSRP associated with the channel, and wherein the first RSRP is associated with a first measurement range, and the second RSRP is associated with a second measurement range;
determining that a second triggering condition has been satisfied, wherein the second triggering condition comprises a condition that the first measurement range associated with the first RSRP and the second measurement range associated with the second RSRP are different;
determining a third data processing model of CSI feedback determination based on the satisfaction of the second triggering condition; and
sending a transmission that indicates the third data processing model of CSI feedback determination and the satisfaction of the second triggering condition.

33. The method of claim 26, further comprising:
determining that a second triggering condition has been satisfied, wherein the second triggering condition comprises a condition that the WTRU changes from using a first bandwidth part (BWP) to using a second BWP, and wherein a frequency range of the first BWP and a frequency range of the second BWP are different;
determining a third data processing model of CSI feedback determination based on the satisfaction of the second triggering condition; and
sending a transmission that indicates the third data processing model of CSI feedback determination and the satisfaction of the second triggering condition.

34. The method of claim 26, wherein the received configuration information indicates a configuration of the first data processing model of CSI feedback determination, a configuration of the second data processing model of CSI feedback determination, and the first triggering condition.

35. The method of claim 26, further comprising receiving a radio resource control message that indicates the first triggering condition.
